(19) United States
(12) Patent Application Publication
(10) Pub. No.: US 2011/0104544 A1
(43) Pub. Date: May 5, 2011

(54) METHOD AND APPARATUS FOR DISASSEMBLING A HERMETICALLY SEALED BATTERY

(75) Inventors: Teik Sin Tan, Pulau (MY); Kow Chee Chong, Bayan Lepas (MY); Macwien Krishnamurthi, Shah Alam (MY); Fathi Mansor, Balik Pulau (MY); Seng Hai Tan, Penang (MY)

(73) Assignee: MOTOROLA, INC., SCHAUMBURG, IL (US)

(21) Appl. No.: 12/609,386

(22) Filed: Oct. 30, 2009

(51) Int. Cl. H01M 2/10; B23P 11/00

(52) U.S. Cl. 429/100; 29/426.4

(57) ABSTRACT

A battery pack includes a cover coupled to a housing, wherein the cover and the housing are hermetically sealed to enclose one or more batteries. A wire is integrally molded within a perimeter of the cover to allow for the removal of the cover from the housing upon application of current to the wire. The wire is molded within the cover so as to be co-located along an edge of the housing. First and second contacts are coupled to the wire and remain exposed on the cover. The cover can be separated from the housing in response to current being applied to the first and second contacts and pulling of the wire.

### FIELD OF THE DISCLOSURE

The present disclosure relates generally to hermetically sealed electronic devices and more particularly to disassembling the content of a hermetically sealed battery pack.

### BACKGROUND

Electronic devices are sometimes hermetically sealed to protect against intrusion from external elements. Portable two-way radios and battery packs are examples of electronic devices which often require a hermetic seal for protection against fluids, smoke and dust. The use of a hermetic seal, particularly when dealing with battery packs, presents challenges to manufacturers seeking to provide environmentally friendly products which can be recycled. Environmental organizations have started emphasizing the need for energy products to be environmentally friendly by implementing mandatory regulations and requirements. However, hermetically sealed battery packs are very difficult to disassemble and therefore difficult to recycle. Additionally, the labor associated with dissembling hermetically sealed battery packs can make recycling costs prohibitive.

Accordingly, there is a need for an improved means of disassembling a hermetically sealed electronic device, particularly a hermetically sealed battery pack.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view illustrating a hermitically sealed battery pack and exploded view of its components in accordance with an embodiment of the invention.

FIG. 2 illustrates a detailed view of a cover of the battery pack and embedded wire in accordance with an embodiment of the invention.

FIG. 3 illustrates a top, side, and front view of the cover of the battery pack in accordance with an embodiment of the invention.

FIG. 4 is a diagram illustrating a technique for disassembling the hermitically sealed battery pack in accordance with an embodiment of the invention.

FIG. 5 is a diagram illustrating the disassembly of the hermitically sealed battery pack in accordance with an embodiment of the invention.

FIG. 6 illustrates a side view of the cover of the battery pack, before and after the embedded wire has been peeled off from the cover in accordance with an embodiment of the invention.

FIG. 7 is a flow chart of a method for disassembling a hermitically sealed battery pack in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Briefly there is described herein, a battery pack including a housing coupled to a cover, wherein the housing and the cover are hermetically sealed to enclose one or more batteries. In accordance with an embodiment, the cover includes an integrally molded wire within a perimeter of the cover with first and second exposed contacts. The wire is molded within the cover so as to be co-located along an edge of the housing, when the cover and housing are coupled together. The cover can be separated from the housing in response to current being applied to the first and second contacts, and pulling of the wire.

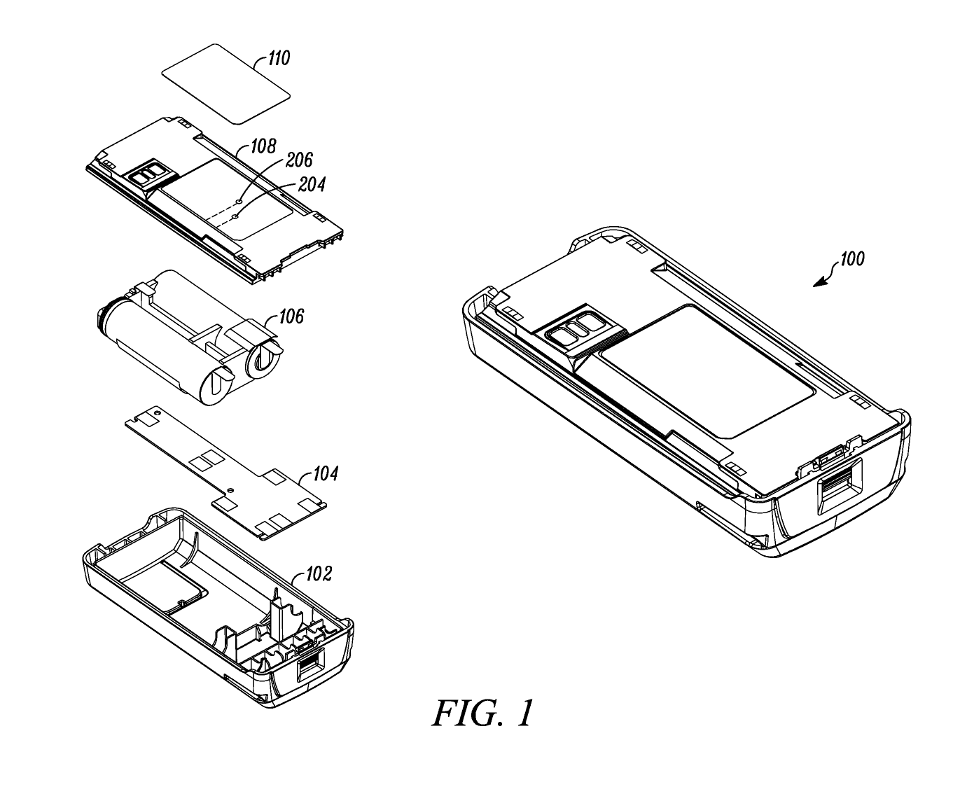

FIG. 1 is a perspective view illustrating a hermitically sealed battery pack 100 and exploded view of components 102-110 in accordance with an embodiment of the invention. The housing enclosure 102 (also referred to as battery pack housing) includes a Printed Circuit Board (PCB) 104 for electrically coupling to a cellpack 106. The cellpack 106 can comprise one or more chargeable cells such as Lithium ion, Nickel Metal Hydride, Nickel Cadmium, or the like. The cellpack 106 is seated within the housing enclosure 102 and covered with a cover 108 formed in accordance with the invention. A label 110 is optionally provided for affixing over contacts 204, 206 located on the surface of the cover 108.

After all the components have been assembled into the housing enclosure 102, the cover 108 is deposited to cover the housing enclosure 102. The complete assembly is hermetically sealed using ultrasonic welding of the cover 108 to the housing enclosure 102. Once the welding is complete, the battery pack 100 can be deployed in a battery powered device such as a portable radio, a mobile phone, a handheld device, a laptop, a music player, a digital camera, or the like.

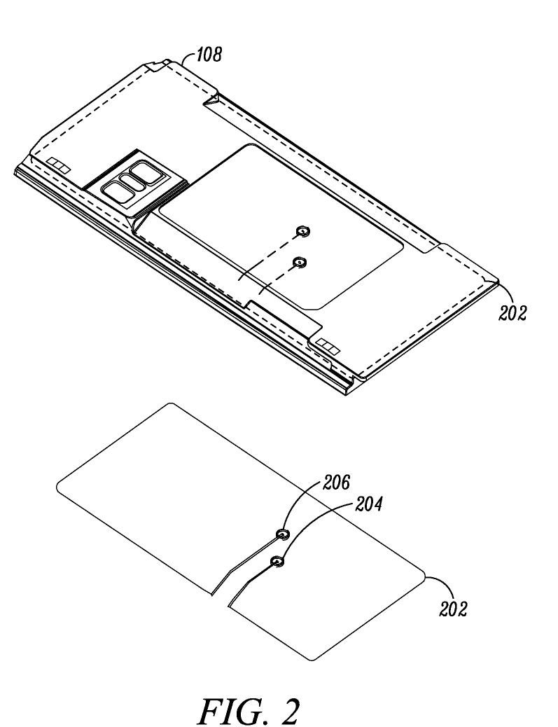

FIG. 2 illustrates a detailed view of the cover 108 of the battery pack in accordance with an embodiment of the invention. The cover 108 and housing enclosure 102 are formed of material suitable for ultrasonic welding, such as poly carbonate materials including, but not limited to, EXL1414, ML6339, or EXL9335 materials or the like. In accordance with the embodiment, the cover 108 includes a high resistance wire 202 embedded therein (represented by dashed lines). The wire 202 is also shown separated from the cover 108 in this view. The wire 202 may be for example, a nichrome wire or other material of suitable resistance, molded along the perimeter of the cover 108. The cover also includes first and second contacts 204, 206 coupled to the ends of the high resistance wire 202. At the time of fabrication of the cover 108, the high resistance wire 202 is molded within the cover 108 such that a portion of the wire is embedded along the perimeter of the cover while the contacts 204, 206 are left exposed on a planar surface of the cover 108. The resistivity of the wire 202 is selected such that it can withstand the amount of heat required to melt or weaken the perimeter joint between the cover and the housing of the battery pack.

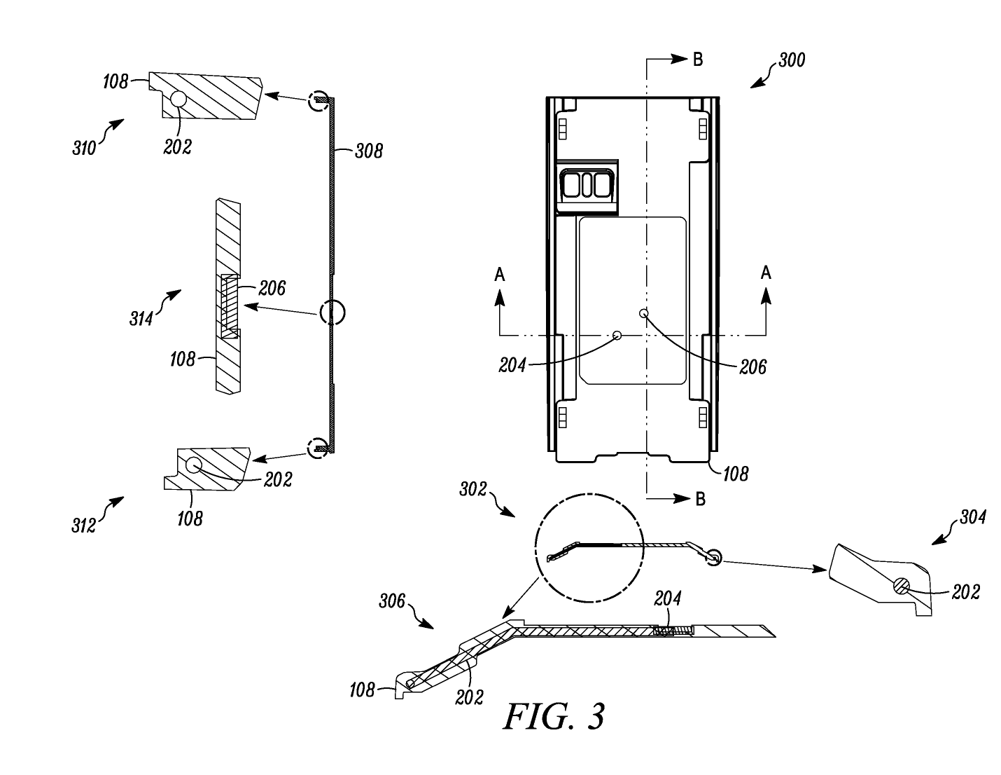

FIG. 3 illustrates top, front cross-sectional, and side cross-sectional views 300, 302, and 308 respectively for the cover 108 of the battery pack 100 in accordance with an embodiment of the invention. The top view 300 shows A-A axis for front cross-sectional view 302 and B-B axis for the side cross sectional view 308.

The front cross-sectional view 302 includes exploded views 304, 306 cut along the A-A axis of cover 108. The exploded view 304 shows an edge of the cover 108 with the high resistance wire 202 molded therein. Exploded view 306 illustrates a portion of the high resistance wire 202 which is embedded across a top portion of the cover extending into exposed contact 204, 206.

The side cross-sectional view 308 includes exploded views 310, 312, 314 cut along portions of the B-B axis of cover 108. The exploded views 310, 312 illustrate the high resistance wire 202 molded along the cover's edge. Exploded view 314 illustrates the second exposed contact 206.

The various views of FIG. 3 thus show the high resistance wire 202 molded along a perimeter of the cover 108 with first and second contacts 204, 206 exposed on a top portion of the cover. Positioning of the high resistance wire 202 in the manner described above provides collocation along the edge of the housing enclosure 102.

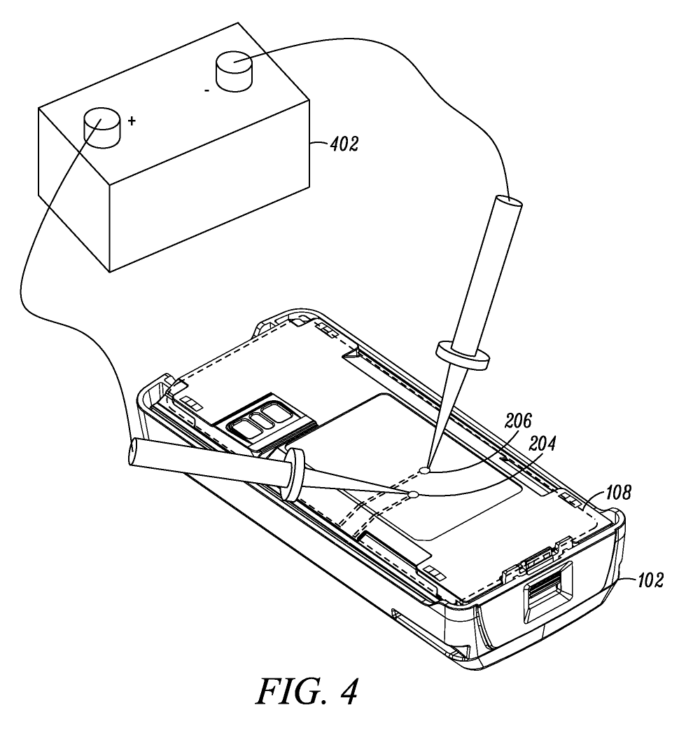

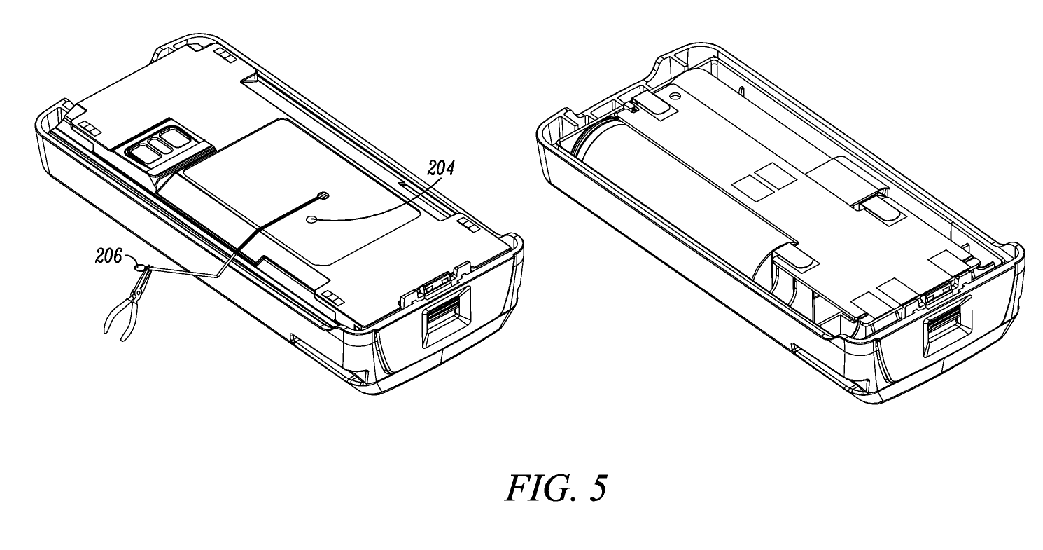

FIGS. 4 and 5 are diagrams illustrating a technique for disassembling the hermitically sealed battery pack 100 in accordance with an embodiment of the invention. Referring to FIG. 4, a user applies a predetermined amount of current, from a current source 402, to the contacts 204, 206 of the battery pack 100, formed in accordance of an embodiment of the invention, for a predetermined amount of time. The amount of current applied is based on the size, thickness, and type of material used in the cover 108 and housing enclosure 102 and the resistance of the embedded wire 202. Once the current is applied to the contacts 204, 206 the current flows through the high resistance wire 202, thus generating heat that either melts or weakens the joint between the battery pack housing enclosure 102 and cover 108.

As seen in FIG. 5, once the joint is weakened, the user can easily separate the cover 108 from the battery pack housing enclosure 102 by pulling off the high resistance wire 202 embedded in the cover 108 to disassemble the battery pack 100. The use of needle nose pliers or any other suitable tool can be used to grab one of the contacts and pull on the wire. Hatched markings are shown on the cover 108 to indicate a track (or open tunnel) left behind as the wire is being pulled away from the cover. This track provides for a weakened edge along the perimeter of the cover 108 as described in the next set of views.

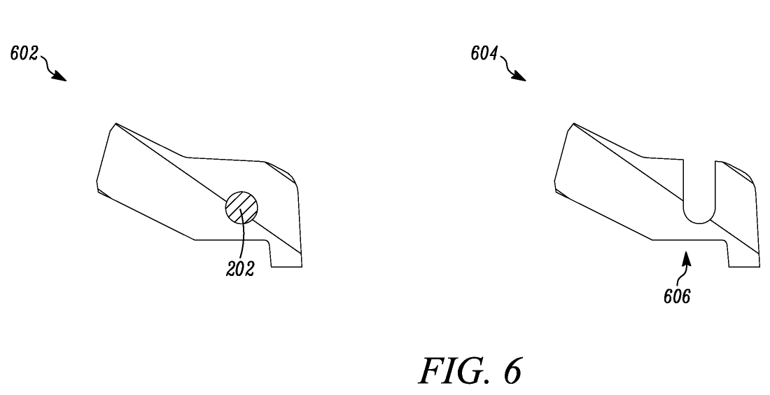

FIG. 6 illustrates a cross-sectional portion of the cover 108 before and after removal of the wire 202 in accordance with an embodiment. View 602 shows the high resistance wire 202 molded within the cover 108. View 604 shows cover 108 after removal of the wire 202. The removal of the wire 202 creates a weakened edge 606 along the perimeter of the cover 108. The weakened edge 606 of the cover 108 creates a weakened joint between the cover and the enclosure. The weakened edge 606 thus facilitates removal of the cover 108 from the housing enclosure 102. The cover may now be removed from the housing enclosure 102 by several means including popping off the cover by hand, or inserting a tool, such as a screwdriver, along the weakened edge 606.

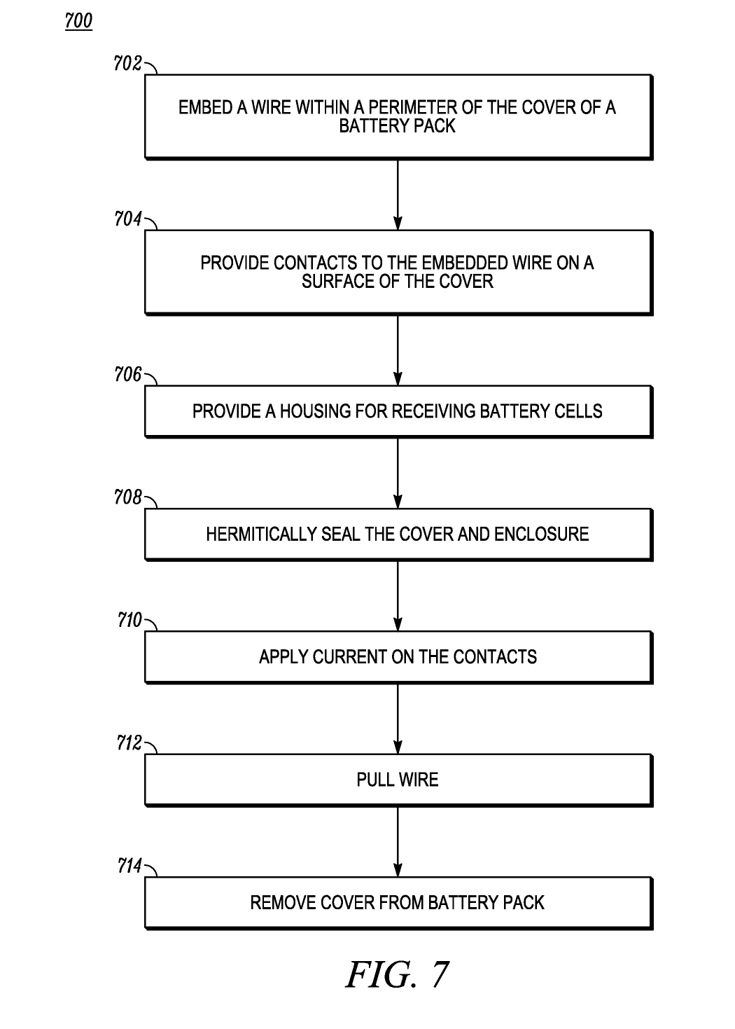

FIG. 7 is a flowchart 700 of a method for disassembling a hermitically sealed battery pack in accordance with some embodiments. While the method 700 is explained using a hermitically sealed battery pack, the method can be implemented to disassemble any kind of hermitically sealed enclosure formed in accordance with an embodiment of the invention.

In accordance with method 700, a high resistance wire is embedded (702) along the perimeter of a cover of a battery pack while the cover is being molded. The wire is embedded such that contacts coupled to the wire are left exposed (704) on a surface of the battery pack cover. A housing is provided to receive the battery cells (706) and the cover 108 is hermetically sealed to the housing enclosure 102 (708). Once the battery pack is sealed and deployed in an electronic device, the battery is eventually discharged and recycling may be desirable or required.

During the recycling process, a predetermined threshold of current is applied to the exposed contacts for a predetermined amount of time (710). This current flows through the high resistance wire and produces heat that will either completely melt or weaken the perimeter joint between the cover and the housing of the battery pack. The high resistance wire is then pulled from the cover (712). The cover is then removed from the battery pack enclosure (714) along the weakened joint.

Prototype testing was conducted using a housing and cover of EXL9335 material with the cover having a perimeter of 300 mm and a nichrome wire having a resistivity of 3.72 milli ohm per mm. On applying a 5 A current to the wire, the joint between the housing and the cover weakened in approx 30 seconds.

Accordingly, there has been provided a hermetically sealed enclosure which can be easily disassembled making the packaging highly desirable for recycling environments. While the method and apparatus have been described primarily in relation to sealed battery packs, hermitically sealed enclosures containing other types of devices can also benefit when formed in accordance with the embodiments of the invention.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A battery pack, comprising:
a housing having a cover;
the housing and the cover hermetically sealing a battery enclosed therein;
a wire integrally molded within a perimeter of the cover, the wire having first and second ends and the wire being co-located along an edge of the housing;
first and second contacts coupled to the cover and to the first and second ends of the wire; and
the cover being separable from the housing in response to current being applied to the first and second contacts.

2. The battery pack of claim 1, wherein the current is applied within a predetermined threshold.

3. The battery pack of claim 2, wherein the current is applied for a predetermined time.

4. The battery pack of claim 1, wherein the molded wire is a high resistance nichrome wire and the cover and housing are formed of a polycarbonate material.

5. The battery pack of claim 1, further comprising: a label coupled to the first and the second contacts.

6. A hermitically sealed enclosure comprising:
a housing having a cover for enclosing a device;
the cover having an integrally molded wire formed therein with contacts exposed on the cover; and
the cover being removable from the housing upon application of electrical current to the contacts.

7. The hermitically sealed enclosure of claim 6, wherein the integrally molded wire has a resistance which sustain the electrical current while an area about the integrally molded wire is weakened from heat generated by the electrical current.

8. The hermitically sealed enclosure of claim 7, wherein the electrical current is applied within a predetermined threshold.

9. The hermitically sealed enclosure of claim 8, wherein the electrical current is applied for a predetermined time.

10. The hermitically sealed enclosure of claim 9, wherein the integrally molded wire is removed from the cover to provide a weakened joint between the cover and the housing.

11. The hermitically sealed enclosure of claim 10, wherein the weakened joint between the cover and the housing allows the cover to be removed from the housing.

12. A method for disassembling a hermitically sealed enclosure, the method comprising:
embedding a wire within a perimeter of a cover;
providing contacts to the embedded wire on a surface of the cover;
hermetically sealing the cover to a housing along the perimeter of the cover; and
applying current on the contacts to disassemble the hermitically sealed enclosure.

13. The method of claim 12, wherein applying current comprises applying current within a predetermined threshold.

14. The method of claim 13, wherein the current is applied for a predetermined time.

15. The method of claim 12, wherein the applied current weakens the hermetic seal along the perimeter of the cover.

16. The method of claim 12, wherein embedding the wire further comprises integrally molding the wire within a perimeter of the cover during fabrication of the cover.

17. The method of claim 12, wherein hermetically sealing the cover to the housing comprises ultrasonically welding the cover to the housing.

18. The method of claim 12, wherein applying current to the contacts causes an area about the embedded wire to weaken.

19. The method of claim 18, wherein applying current to the contacts further comprises:
pulling the wire from the weakened area of the cover; and
removing of the cover from the housing.
